(19) United States
(12) Patent Application Publication
(10) Pub. No.: US 2014/0242345 A1
(43) Pub. Date: Aug. 28, 2014

(54) COMPOSITION FOR NANO-COMPOSITE LAYER WITH SUPERHYDROPHOBIC SURFACES, NANO-COMPOSITE LAYER WITH SUPERHYDROPHOBIC SURFACES FORMED THEREFROM, AND PREPARING METHOD THEREOF

(71) Applicant: Samsung Electronics Co., Ltd., Suwon-si (KR)

(72) Inventors: Sung-hoon PARK, Seoul (KR); Sang-eui LEE, Hwaseong-si (KR); Dong-ouk KIM, Pyeongtaek -si (KR); Byung-hoon KIM, Seongnam-si (KR)

(73) Assignee: Samsung Electronics Co., Ltd., Suwon-si (KR)

(21) Appl. No.: 14/188,897

(22) Filed: Feb. 25, 2014

(30) Foreign Application Priority Data
Feb. 28, 2013 (KR) 10-2013-0022456

(51) Int. Cl. H01B 1/24; H01B 13/00

(52) U.S. Cl. CPC H01B 1/24; H01B 13/00; H01B 13/0016
USPC 428/172; 252/511; 264/241; 264/232

(57) ABSTRACT

A method of preparing a nano-composite layer comprising superhydrophobic surfaces, the method comprising: providing a first roll and a second roll with a predetermined gap therebetween; rotating the first roll and the second roll in a direction towards each other, wherein a linear velocity of the first roll is greater than a linear velocity of the second roll; supplying a composition for the nano-composite layer to the predetermined gap to form a composition layer having a first thickness on a circumference of the first roll; adjusting the linear velocity of the first roll, the second roll, or both, such that the linear velocity of the second roll is greater than or equal to the linear velocity of the first roll to form the nano-composite layer; and separating the nano-composite layer from the first roll.

### CROSS-REFERENCE TO RELATED APPLICATION

This application claims priority to and the benefit of Korean Patent Application No. 10-2013-0022456, filed on Feb. 28, 2013, and all the benefits accruing therefrom under 35 U.S.C. §119, the content of which is incorporated herein in its entirety by reference.

### BACKGROUND

1. Field

The present disclosure relates to a composition for a nano-composite layer with superhydrophobic surfaces, the nano-composite layer with superhydrophobic surfaces formed therefrom, and preparing method thereof.

2. Description of the Related Art

A nano-composite, such as a carbon nano tube composite, has excellent electrical, mechanical, and electromagnetic properties. For example, if a polymer nano-composite is formed by combining a polymer, which is an insulator with weak mechanical strength, with nano materials, such as carbon nano-tubes, carbon fibers, graphene, etc., properties of the polymer may be retained while its electric conductivity and mechanical strength may be improved. Such nano-composites find applications in various fields, such as electronic component packaging, lightweight materials, sensors, and electromagnetic wave shielding and absorbing materials.

However, if a nano-composite is used while being exposed to an outside environment, it may be damaged or deteriorated due to rain, wind, or other atmospheric moisture. To solve the problem, the surfaces of a nano-composite may need to be treated, which adds to the cost of manufacturing the nano-composite.

### SUMMARY

Provided are compositions for nano-composite layers with superhydrophobic surfaces, the nano-composite layer with superhydrophobic surfaces formed therefrom, and a method of preparing thereof.

Additional aspects will be set forth in part in the description which follows and, in part, will be apparent from the description, or may be learned by practice of the presented embodiments.

According to an aspect of the present inventive concept, there is provided a method of preparing a nano-composite layer with superhydrophobic surfaces, the method including:

providing a first roll and a second roll with a predetermined distance therebetween;

rotating the first roll and the second roll in a direction towards each other, wherein a linear velocity of the first roll is greater than a linear velocity of the second roll;

supplying a composition for the nano-composite layer to the predetermined gap to form a composition layer having a first thickness on a circumference of the first roll; adjusting the linear velocity of the first roll, the second roll, or both, such that the linear velocity of the second roll is greater than or equal to the linear velocity of the first roll to form the nano-composite layer; and

separating the nano-composite layer from the first roll,

wherein the composition for the nano-composite layer with superhydrophobic surfaces comprises a polymer and a nano-filler, and has a viscosity of about 10⁴ Pascals×second to about 10⁸ Pascals×second and a thixotropic index of 3 or greater.

According to another aspect of the present inventive concept, there is provided a method of preparing a nano-composite layer with superhydrophobic surfaces, the method including:

providing a dispenser supplying a composition for the nano-composite layer with superhydrophobic surfaces, a first apparatus for adjusting a thickness of the composition, a first roll, and a conveyer belt at a predetermined distance from the first roll;

rotating the first roll and the conveyer belt in a direction towards each other;

dispensing the composition for the nano-composite layer from the dispenser onto the conveyer belt before contacting the first roll;

contacting the dispensed composition with the first apparatus to form a composition layer having a first thickness;

forming a nano-composite layer by contacting the composition layer with the first roll, wherein a linear velocity of the first roll is greater than or equal to a linear velocity of the conveyer belt; and

separating the nano-composite layer from the conveyer belt,

wherein the composition for the nano-composite layer with superhydrophobic surfaces includes a polymer and a nano-filler, and has a viscosity of about 10⁴ Pascals×second to about 10⁸ Pascals×second and a thixotropic index of equal to or greater than 3.

According to another aspect of the present inventive concept, there is provided a composition for a nano-composite layer with superhydrophobic surfaces including a polymer and a nano-filler, wherein a viscosity of the composition is about 10⁴ Pascals×second to about 10⁸ Pascals×second and a thixotropic index is equal to or greater than 3.

According to another aspect of the present inventive concept, there is provided a nano-composite layer with superhydrophobic surfaces or a nano-composite layer with superhydrophobic surfaces comprising a cured product of the composition including:

a bulk body;

a plurality of protrusions formed on the bulk body; and

nano-fillers exposed on surfaces of the plurality of protrusions.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view schematically illustrating a cross-section of an apparatus used in preparing a nano-composite layer with superhydrophobic surfaces according to an embodiment;

FIG. 2A is a plan view illustrating an example of a surface of a second roll used in a method preparing the nano-composite layer with superhydrophobic surfaces according to an embodiment;

FIG. 2B is a plan view illustrating an example of a surface of a second roll used in a method of preparing the nano-composite layer with superhydrophobic surfaces according to another embodiment;

FIG. 3 is an illustration of a method of preparing a nano-composite layer with superhydrophobic surfaces according to an embodiment;

FIGS. 4A and 4B are respectively a low magnification scanning electron microscope (“SEM”) image of a nano-composite layer at a magnification of 200 and a high magnification scanning electron microscope (“SEM”) image of the nano-composite layer at a magnification of 10,000, when a velocity of a first roll is 55 rounds per minute (“rpm”) and a contact angle is 161°;

FIG. 4C is a transmission electron microscope image of a nano-composite layer when a velocity of a first roll is 55 rounds per minute (“rpm”) and a contact angle is 161° according to an embodiment;

FIG. 4D is a graph of viscosity (Pascals×second, Pa×s) versus angular velocity (rounds per minute, rpm) illustrating viscosity properties according to angular velocities of a composition for a nano-composite layer according to an embodiment;

FIG. 5 is a graph of temperature (degree Centigrade, ° C.) versus lapse of time (second, s) evaluating conductivity of a nano-composite layer according to an embodiment;

FIG. 6 is a graph of thickness of frost layer (millimeter, mm) versus time for frost formation (minute, min) illustrating anti-frost effects of a nano-composite layer according to an embodiment;

FIG. 7A is a graph of contact angle (degree) versus sliding cycle number illustrating results of a durability test of a nano-composite layer according to an embodiment, and a general pillar-type nano-composite layer;

FIG. 7B is a scanning electron microscope (“SEM”) image of a nano-composite layer according to an embodiment after evaluating its durability;

FIGS. 7C and 7D are respectively SEM images of a general pillar-type nano-composite layer before and after evaluating its durability;

FIG. 8 is a schematic illustration of a cross-section of an apparatus used in a method of preparing a nano-composite layer with superhydrophobic surfaces according to another embodiment;

FIG. 9 is a schematic illustration of a cross-section of a structure of a nano-composite layer according to an embodiment;

FIG. 10 is an illustration of a contact angle between vapor in the air and a solid when a liquid drop is located on a surface of the solid; and

FIG. 11 is an illustration of a rectangular pillar irregularities formed on a surface of a solid.

### DETAILED DESCRIPTION

Hereinafter, an exemplary composition for a nano-composite layer with superhydrophobic surfaces, the nano-composite layer with superhydrophobic surfaces formed therefrom, and a method of preparing thereof will be described in detail. Thicknesses of layers or areas illustrated herein are exaggerated for clarity. The embodiments described below are for illustrative purposes only and the present embodiments may be variously transformed. Hereinafter, expressions such as an “upper portion” or the “top” not only include an object being located on the top by a contact, but also without a contact. Like reference numerals refer to like elements throughout and detailed description thereof will be omitted.

It will be understood that when an element is referred to as being “on” another element, it can be directly in contact with the other element or intervening elements may be present therebetween. In contrast, when an element is referred to as being “directly on” another element, there are no intervening elements present.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of the present embodiments.

The terminology used herein is for the purpose of describing particular embodiments only and is not intended to be limiting. As used herein, the singular forms “a,” “an,” and “the” are intended to include the plural forms as well, unless the context clearly indicates otherwise.

The term “or” means “and/or.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

As used herein, the term “alkyl” means a straight or branched chain saturated aliphatic hydrocarbon having the specified number of carbon atoms and having a valence of at least one. Non-limiting examples of alkyl are methyl, ethyl, and propyl.

As used herein, the term “alkoxy” means an alkyl group that is linked via an oxygen (i.e., alkyl-O—). Non-limiting examples of “alkoxy” are methoxy, ethoxy, and propoxy.

As used herein, the term “alkenyl” means a straight or branched chain hydrocarbon that comprises at least one carbon-carbon double bond and having a valence of at least one. Non-limiting examples of alkylene are ethylene and propylene.

As used herein, the term “aryl” means a cyclic group in which all ring members are carbon and at least one ring is aromatic, the group having the specified number of carbon atoms, and having a valence of at least one. Non-limiting examples of aryl are phenyl and naphthyl.

A composition for a nano-composite layer with superhydrophobic surfaces includes a polymer and a nano-filler, and has a viscosity of about 10⁴ Pascals×second·(Pa×S) to about 10⁸ Pa×S, and a thixotropic index of 3 or greater.

The expression “the nano-composite layer with superhydrophobic surfaces” as used herein refers to a nano-composite layer having superhydrophobic surfaces. The term “superhydrophobic” as used herein refers to a surface having a contact angle of 140° or greater, for example, 150° or greater, or, for example, about 140° to about 180°.

The term “viscosity” as used herein refers to a resistance value of a flow of a liquid composition. A viscosity of the composition may be, for example, about 10⁶ Pa×S to about 10⁸ Pa×S when an angular velocity is about 0.1 radians per second (“rad/s”) to about 100 (“rad/s”). When the viscosity of the composition is less than 10⁴ Pa×S or greater than 10⁸ Pa×S, an external force may be applied to the composition in a liquid state, thus making the nano-composite layer with superhydrophobic surfaces difficult to obtain because of a weak ability of the composition to maintain its shape.

The term “thixotropic index” as used herein refers to an ability of the composition to form a shape as a result of the application of the external force when the composition is in a liquid state. The greater the value of the thixotropic index, the greater the tendency of the composition to maintain its shape after the external force is applied. The thixotropic index is represented by Equation 1 below.

Thixotropic index=(a viscosity at 0.5 rpm)/(a viscosity at 5 rpm) Equation 1

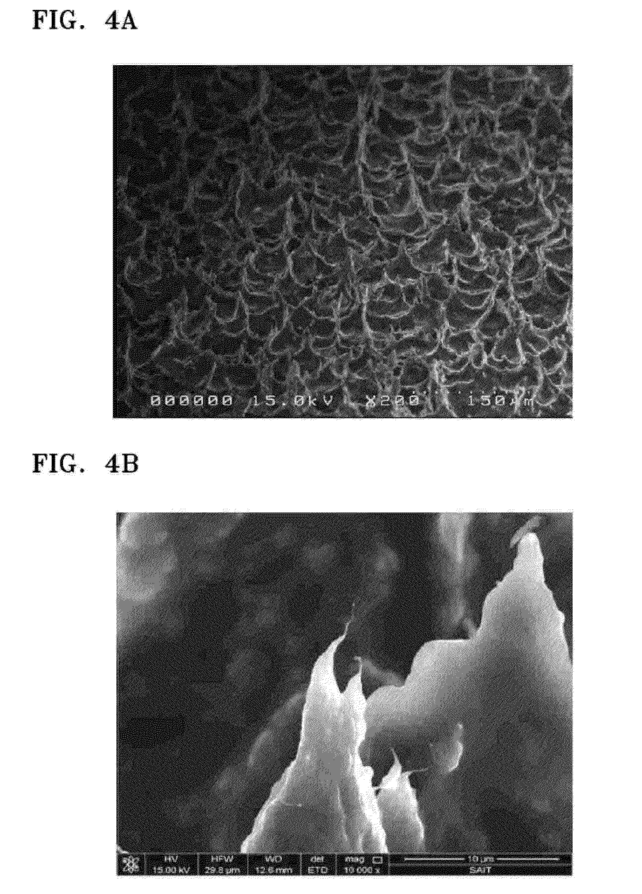

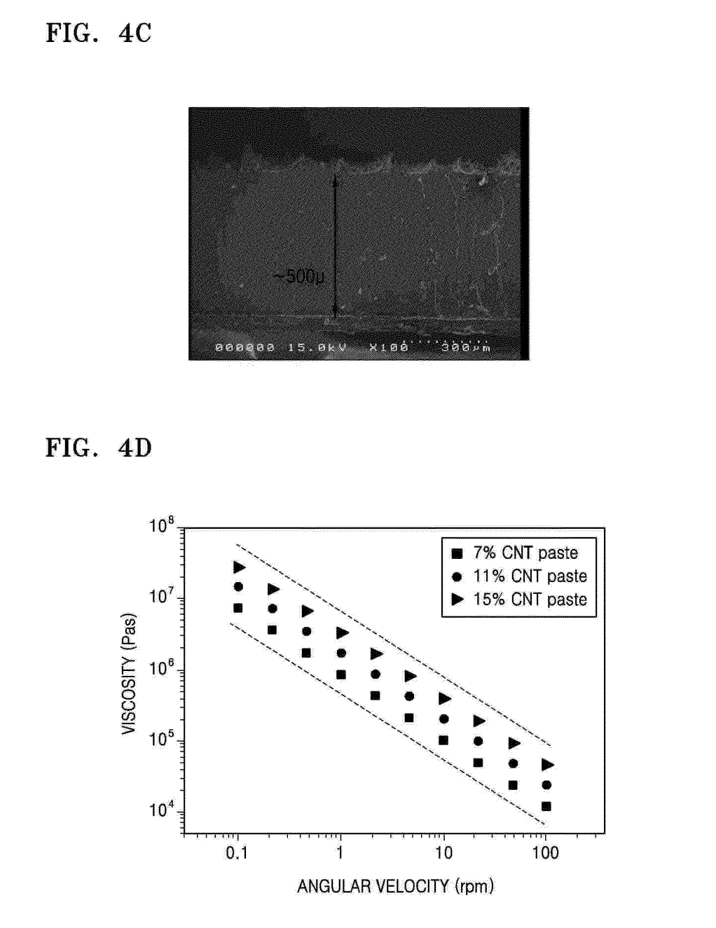

As illustrated in Equation 1 above, the thixotropic index is calculated from a ratio of the viscosity at 0.5 rounds per minute (“rpm”) to the viscosity at 5 rpm. The rpm may be obtained from FIG. 4D by Equation 2 below.

1 rad/s=60/2π rpm Equation 2

A thixotropic index of the composition for the nano-composite layer may be 3 or greater, for example, about 3 to about 100, and for example, about 4 to about 10. The composition having the thixotropic index above may change its shape when the external force is applied, and, the composition may maintain that shape until an additional external force is applied.

When the thixotropic index of the composition is less than 3, it is difficult to obtain a superhydrophobic nano-composite layer with superhydrophobic surfaces because the ability of the liquid to maintain its shape obtained as a result of the external force is low.

Both a thermoplastic polymer and a curable polymer may be used as the polymer.

The curable polymer may be, for example, at least one selected from polyorganosiloxane, polyurethane, unsaturated polyester, phenolic, an epoxy resin, an alkyd molding compound, and an allyl resin.

When the curable polymer is used as the polymer, a cross-linkage may form in the curable polymer during the preparation of the nano-composite layer. In some embodiments, a cross-linking compound may be further added to the composition for the nano-composite layer.

The polyorganosiloxane has a siloxane repeat unit represented by Formula 1 below, and may have a weight average molecular weight of about 200 to about 300,000.

—SiR¹R²O— Formula 1

In Formula 1 above, R¹ and R² may be each independently a substituted or unsubstituted C1-C10 alkyl group, a substituted or unsubstituted C1-C10 alkoxy group, a substituted or unsubstituted C2-C10 alkenyl group, or a substituted or unsubstituted C6-C20 aryl group.

The polyorganosiloxane may be, for example, at least one selected from polydimethylsiloxane (“PDMS”), polymethylphenylsiloxane, polydiphenylsiloxane, polyfluorosiloxane, and polyvinylsiloxane, a copolymer thereof, or a mixture thereof, having a curable or crosslinkable group.

Non-limiting examples of the thermoplastic polymer include reactive ethylene terpolymer (“RET”), ethylene/propylene/diene terpolymers (“EPR”), acrylonitrile butadiene-styrene copolymer (“ABS”), polymethyl methacrylate, methylpentene polymer, a polyimide, polyvinylidene fluoride, polyvinylidene chloride, a polycarbonate, polystyrene, a polyamide, a polyester such as polyethylene terephthalate, and the like.

The nano-filler may control the viscosity of the composition for the nano-composite layer. Also, a nano-composite layer having improved tensile strength, elastic modulus, and toughness may be obtained by adding the nano-filler.

The nano-filler may have conductivity or insulating properties.

Examples of the nano-filler include carbon black, carbon nano-tubes, carbon fibers, nano-wires, graphene, nano-particles, alumina, zirconia, and a mixture thereof. The carbon nanotubes may be single-walled carbon nanotubes or multi-walled carbon nanotubes.

Examples of the nano-wires include silicon (Si) nano-wires, zinc oxide (ZnO) nano-wires, copper (Cu) nano-wires, and gallium nitride (GaN) nano-wires.

The content of the nano-filler may be about 5 percent by weight (weight %) to about 20 weight % based on a total weight of the composition for the nano-composite layer, and may be, for example, about 7 weight % to about 15 weight %. When the content of the nano-filler is within the ranges above, the nano-composite layer with surfaces having an excellent hydrophobicity may be obtained without a reduction in workability caused by an excessively high viscosity of the composition.

The aspect ratio of the nano-filler may be about 5,000 to about 20,000.

The nano-filler may be carbon nano-tubes according to an embodiment.

The nano-filler may have a diameter of about 1 nanometers (“nm”) to about 1,000 nm, and a length of about 0.01 micrometers (“μm”) to about 1,000 μm.

A diameter of the nano-filler may be, for example, about 10 nm to about 20 nm, and the length may be, for example, about 100 μm to about 200 μm.

Functionalized carbon nano-tubes may be used as the nano-filler.

The functionalized carbon nano-tubes refer to carbon nano-tubes (“CNT”) wherein a functional group capable of reacting with a functional group of the polymer is added. The functional group includes, for example, a hydroxy group, a carboxyl group, an amino group, or the like. When the functionalized CNTs are used as fillers, the functionalized carbon nano-tubes connect to the polymer of the composition for the nano-composite layer through chemical bonds, thereby forming a CNT-polymer composite. When the composite is used, the nano-composite layer with excellent hydrophobicity may be formed.

According to an embodiment, a CNT-polymer composite represented by Formula 3 may be prepared through a process of introducing a carboxyl group to a CNT to obtain a carboxyl group-containing CNT, reacting the carboxyl group-containing CNT with a polymer of a composition for forming the nano-composite layer (for example, the reactive ethylene terpolymer (“RET”) of the following Formula 2), and forming a chemical bond (for example, an ester bond) between the carboxyl group-containing CNT and the polymer. The CNT-polymer composite may be used to prepare the nano-composite layer having the superhydrophobic surfaces.

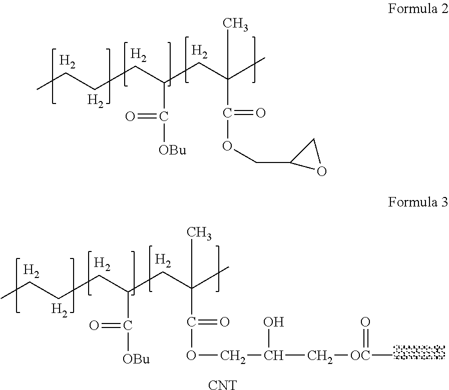

The composition for the nano-composite layer according to an embodiment may be obtained by mixing the polymer with the nano-filler.

During mixing of the polymer and the nano-filler, a mixer may be used for an effective dispersion of the nano-filler.

An example of the mixer includes a paste mixer, wherein the paste mixer may be mixed by purring the polymer and the nano-filler into a container in a desired amount and then revolving and rotating the mixture of the polymer and the nano-filler.

After the polymer and the nano-filler are mixed for several minutes by using the mixer to prepare a mixture, the mixture may be milled to control an aspect ratio of the nano-filler such as CNT.

A 3-roll milling machine may be used for the milling. After the milling, a length of the nano-filler such as CNT may be controlled to obtain a composition for a nano-composite layer having a desired viscosity and a thixotropic index.

When a conductive material is used as the nano-filler of the composition for the nano-composite layer, the nano-composite layer may have conductivity. Also, when an insulating material is used as the nano-filler, a nano-composite layer having an insulating property may be obtained.

An aspect ratio of the nano-filler of the composition for the nano-composite layer may be about 500 to about 20,000, for example, about 1,000 to about 10,000, and for example, about 3,000 to about 6,000.

The aspect ratio of the nano filer has a major effect on the viscosity and thixotropic index of the composition for the nano-composite layer. When the aspect ratio of the nano-filler is in the ranges above, the nano-composite layer with surfaces having an excellent hydrophobicity may be obtained.

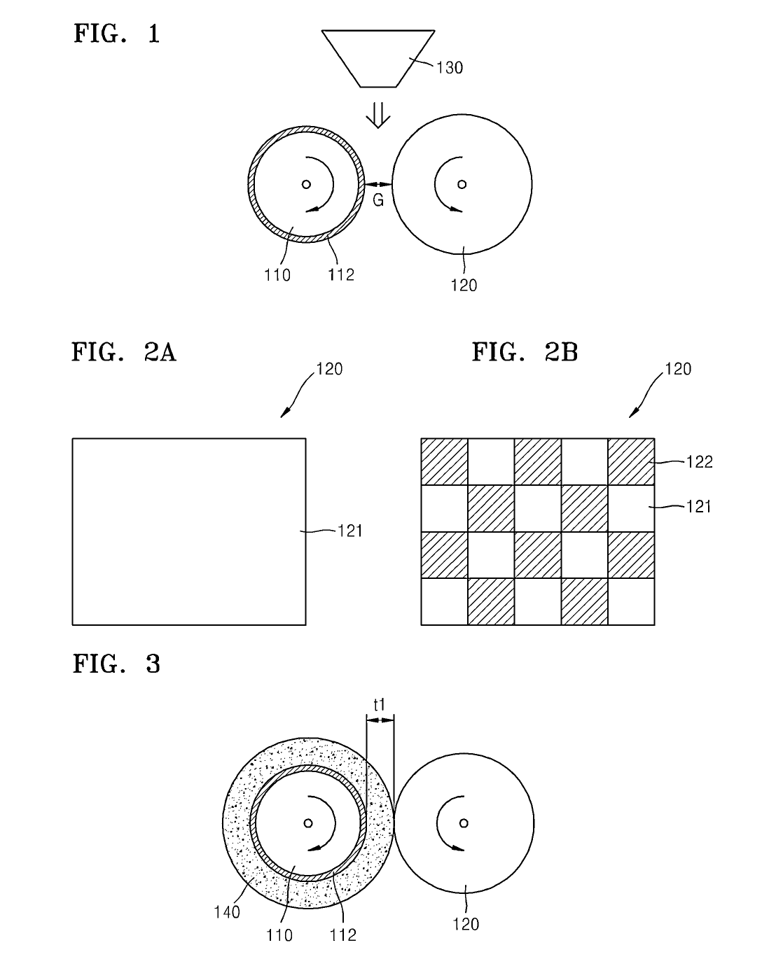

FIG. 1 schematically illustrates a cross-section of an apparatus used in preparing the nano-composite layer with superhydrophobic surfaces according to an embodiment.

Referring to FIG. 1, a first roll 110 and a second roll 120 are disposed to face each other. The first roll 110 and the second roll 120 are separated from each other by a first gap G. A dispenser 130 supplying a composition for the nano-composite layer is disposed on or over the first gap G of the first roll 110 and the second roll 120. The first roll 110 and the second roll 120 may each be formed of stainless steel.

A surface of the second roll 120 may be processed to have a soft or a rough surface. Also, a surface of the second roll 120 may be entirely or partly formed of a rough surface.

Also, the surface of the second roll 120 may have a soft surface (an unprocessed surface) as illustrated in FIG. 2A. Also, the surface of the second roll 120 may have a rough surface (a roughly processed surface 121) and a soft surface (an unprocessed surface 122) that regularly alternate.

Reference number 112 denotes a release layer, which will be described in detail below.

Hereinafter, a method of preparing the nano-composite layer with superhydrophobic surfaces according to an embodiment will be described with reference to the drawings.

First, a first roll 110 and a second roll 120 are disposed such that a surface of the first roll 110 and a surface of the second roll 120 form a first gap G. The release layer 112 such as a polyimide layer may be further attached to a circumference of the first roll 110. The attachment of the release layer 112 will be described below.

The first roll 110 and the second roll 120 are each rotated in a direction towards each other as shown in FIG. 1. Here, a linear velocity of the first roll 110 is greater than a linear velocity of the second roll 120.

Thereafter, a composition for the nano-composite layer according to an embodiment is inserted into gap G from the dispenser 130. The composition for the nano-composite layer includes the polymer and the nano-filler. The viscosity of the composition for the nano-composite layer is about 10⁴ Pa×S to about 10⁸ Pa×S, and the thixotropic index of the composition is equal to or greater than 3 as described above. The composition for the nano-composite layer is dispensed by an amount for forming one layer on the first roll 110 in a first thickness corresponding to the length of the first gap G.

Referring to FIG. 3, a composition layer 140 is formed having the first thickness t1 on the circumference of the first roll 110.

The polymer may be a curable polymer or a thermoplastic polymer.

When the polymer is the thermoplastic polymer, the composition layer 140 wrapped on the first roll 110 is heated. A heating temperature of the composition layer 140 varies according to the composition, and the temperature may be about 100° C. to about 250° C. When the composition layer 140 is heated at the temperature in the range above, the thermoplastic polymer is heated up to a softening or melting point of the thermoplastic polymer, thereby controlling a viscosity of the composition layer 140 including the thermoplastic polymer from about 10⁴ Pa×S to about 10⁸ Pa×S and controlling the thixotropic index equal to or greater than 3 to obtain the nano-composite layer with superhydrophobic surfaces.

Thereafter, the linear velocity of the first roll 110 and/or the second roll 120 are/is adjusted such that the linear velocity of the second roll 120 is greater than or equal to the linear velocity of the first roll 110. For example, the linear velocity of the first roll 110 may be adjusted to be equal to or lower than the linear velocity of the second roll 120, while maintaining a constant linear velocity of the second roll 120. Alternatively, the linear velocity of the second roll 120 may be increased while maintaining a constant linear velocity of the first roll 110.

When the linear velocity of the second roll 120 increases relatively, a shear stress is applied to the surface of the composition layer 140 in a direction opposite to a rotation direction of the first roll 110 and thus, a portion of the surface of the composition layer 140 is detached from the first roll 110. As a result, a superhydrophobic nano-pattern is formed on the surface of the composition layer 140. Some detached portion of the composition layer 140 may be attached onto the surface of the second roll 120. The resultant layer on the first roll 110 is the nano-composite layer with superhydrophobic surfaces.

The shear stress is proportional to a shear rate. The shear rate is calculated by dividing a value obtained by subtracting the linear velocity of the second roll from the linear velocity of the first roll when adjusting the linear velocity of the first roll and/or the second roll, by the first thickness t1, and may be, for example, about 0 second (“s⁻¹”) to about −200 s⁻¹.

Thereafter, the nano-composite layer is separated from the first roll 110 after the first roll 110 is stopped. When the release layer 112 is attached to the first roll 110, the nano-composite layer may be easily separated from the release layer 112.

When the curable polymer is used as the polymer of the composition for the nano-composite layer, the curable polymer is further cured, for example by heating the nano-composite layer separated from the first roll. Other methods of cure may be used as is known in the art.

A curing temperature of the nano-composite layer including the curable polymer may be about 100° C. to about 200° C.

Table 1 shows experimental examples according to the embodiment above.

TABLE 1

| The first roll | | The second roll | | | | |
|---|---|---|---|---|---|---|
| Number | | Number | | | | |
| of | | of | | Velocity | Shear | Contact |
| revol- | Velocity | revol- | Velocity | difference | rate | angle |
| utions | (V1) | utions | (V2) | (dV) | (dV/t) | (°) |
| 100 | 0.126 | 70 | 0.11 | 0.016 | 32 | 101 |
| 87.5 | 0.11 | 70 | 0.11 | 0 | 0 | 140 |
| 70 | 0.088 | 70 | 0.11 | −0.022 | −44 | 149 |
| 55 | 0.069 | 70 | 0.11 | −0.041 | −82 | 161 |
| 45 | 0.057 | 70 | 0.11 | −0.053 | −106 | 145 |

In Table 1, the unit of the number of revolutions is revolutions per minute (“rpm”), the velocity is the linear velocity and the unit thereof is meters per second (“m/s”), the velocity difference is calculated as V1−V2, and the shear rate is calculated by dividing the velocity difference by the first thickness t1 of the composition layer 140 formed on the first roll 110 and the unit thereof is 1/second (“1/s”). The t1 was about 500 μm. The diameter of the first roll was about 0.024 meters (“m”), and the diameter of the second roll was about 0.03 m.

Referring to the data in Table 1, the velocity of the first roll 110 was gradually reduced while uniformly maintaining the velocity of the second roll 120, and the shear rate changed accordingly.

A mixture of 89 weight % of polydimethylsiloxane (“PDMS”) that is a curable polymer and 11 weight % of multi-wall carbon nanotubes (“MWCNT”) was used as the composition for the nano-composite layer of the Example of Table 1 above. The method of preparing the composition for the nano-composite layer is described as follows.

89 weight % of PDMS (Sylgard 184 SILICONE ELASTASTOMER BASE available from Dow Corning Co.) and 11 weight % of MWCNT that is a filler (a diameter of about 10 nm to about 20 nm, a length of about 100 μm to about 200 μm, and an aspect ratio of about 3,000 to about 20,000, available from Hanhwa Nanotech Co.) were mixed to obtain the composition for the nano-composite layer.

The composition for the nano-composite layer was mixed in a paste mixer (PDM-1 k available from DAE HWA TECH) for about 1 minute to about 5 minutes, and milled in a ceramic 3 roll mill (available from INOUE MFG. INC) for about 25 minutes.

After the milling, a final aspect ratio of the MWCNT in the nano-composite layer composition was about 5,000. A viscosity of the composition for the nano-composite layer obtained by the method above was about 1,418,000 Pa×S to about 24,010 Pa×S in a range of an angular velocity of about 0.1 rad/s to about 100 rad/s, and the thixotropic index was 8.2.

The viscosity was measured at a temperature of 20° C. by using AR2000 available from TA Instruments.

The thixotropic index was obtained by calculating each viscosity when the composition was under the conditions of angular velocities at 0.5 rpm and 5 rpm, respectively, and by using FIG. 4D.

FIG. 4D is a graph of viscosity (Pa×s) versus angular velocity (rpm) for a composition for the nano-composite layer including 89 weight % of PDMS which is a curable polymer and 11 weight % of MWCNT, a composition for the nano-composite layer including. 93 weight % of PDMS and 7 weight % of the MWCNT, prepared in the same manner as the previous composition, and a composition for the nano-composite layer including 85 weight % of PDMS and 15 weight % of MWCNT, prepared in the same manner as the previous compositions.

With respect to the contact angle of the nano-composite layer of Table 1 above, when the shear rate is 0 or less (hence, 0 s⁻¹, −44 s⁻¹, −82 s⁻¹, or −106 s⁻¹), the contact angle is 140° or greater (hence, 140°, 149°, 161°, or 145°). Accordingly, it may be inferred that surfaces of the nano-composite layer 140 have superhydrophobicity.

The results in Table 1 are based on using the nano-composite layer composition including 89 weight % of PDMS that is a curable polymer and 11 weight % of MWCNT. The contact angle may vary according to contents of the nano-composite materials and the nano-fillers, and the like. The shear rate for forming the nano-composite layer having superhydrophobic surfaces is about 0 s⁻¹ to about −200 s⁻¹.

FIGS. 4A and 4B are respectively a low magnification SEM image of the nano-composite layer at 200× and a high magnification SEM image of the nano-composite layer at 10,000×, when the velocity of the first roll is 55 rpm and the contact angle is 161° as shown in Table 1 above.

FIG. 4C is a transmission electron microscope (“TEM”) image of the nano-composite layer when a velocity of a first roll is 55 rpm and a contact angle is 161° as shown in Table 1 above.

FIG. 4A illustrates some surfaces of the nano-composite layer with superhydrophobic surfaces separated from surfaces of the nano-composite layer with superhydrophobic surfaces.

Referring to FIG. 4B, a plurality of protrusions are formed on the top of a bulk body of the nano-composite layer with superhydrophobic surfaces, wherein the nano-fillers are attached to the surfaces of the protrusions. The protrusions are micro-sized and MWCNT, that is the nano-filler, is nano-sized. The protrusions increase the contact angle and the nano-fillers further increase the contact angle.

FIG. 4C illustrates a plurality of protrusions having a pyramid structure on the top surface of a bulk body of the nano-composite layer with superhydrophobic surfaces.

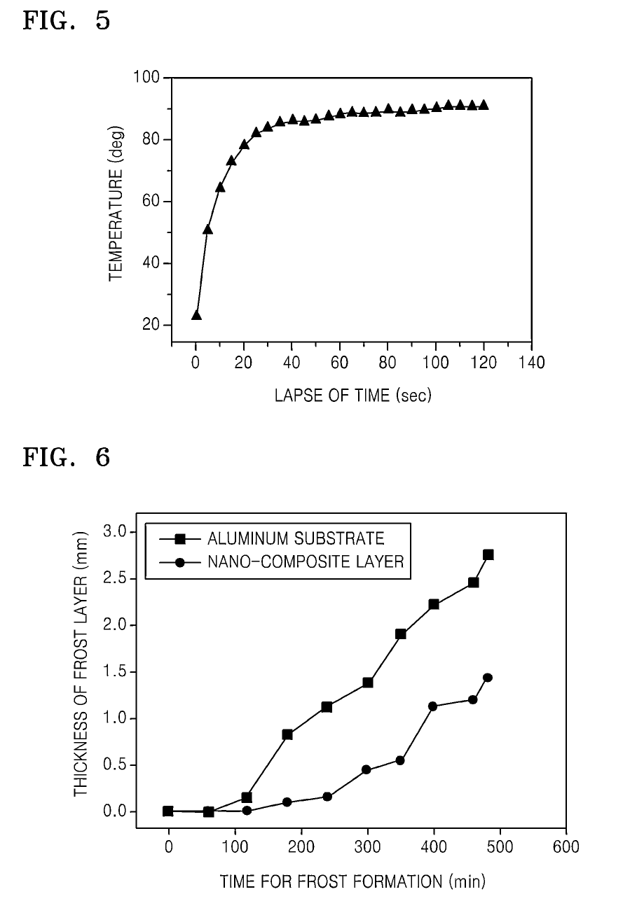

FIG. 5 is a graph evaluating conductivity of the nano-composite layer when a velocity of a first roll is 55 rpm and a contact angle is 161° as shown in Table 1.

The conductivity was evaluated by investigating a change in temperature according to time by applying a voltage of about 12 volts (“V”) to the nano-composite layer.

As illustrated in FIG. 5, the nano-composite layer reached 100° C. within 30 seconds. Accordingly, a heat generation through an electric joule heating may be possible because of the excellent conductivity of the nano-composite layer.

FIG. 6 illustrates anti-frosting effects of the nano-composite layer when a velocity of a first roll is 55 rpm and a contact angle is 161°, as shown in Table 1.

The anti-frosting effects were evaluated according to the method below.

When the velocity is 55 rpm and the contact angle is 161° (as shown in Table 1), the nano-composite layer was laminated on an aluminum substrate to obtain a structure. The structure and the aluminum substrate were maintained at a temperature of −30° C. for 8 hours and a thickness of frost formed on the structure and the aluminum substrate was measured.

As illustrated in FIG. 6, the nano-composite layer has excellent anti-frosting effects compared to that of a general aluminum substrate.

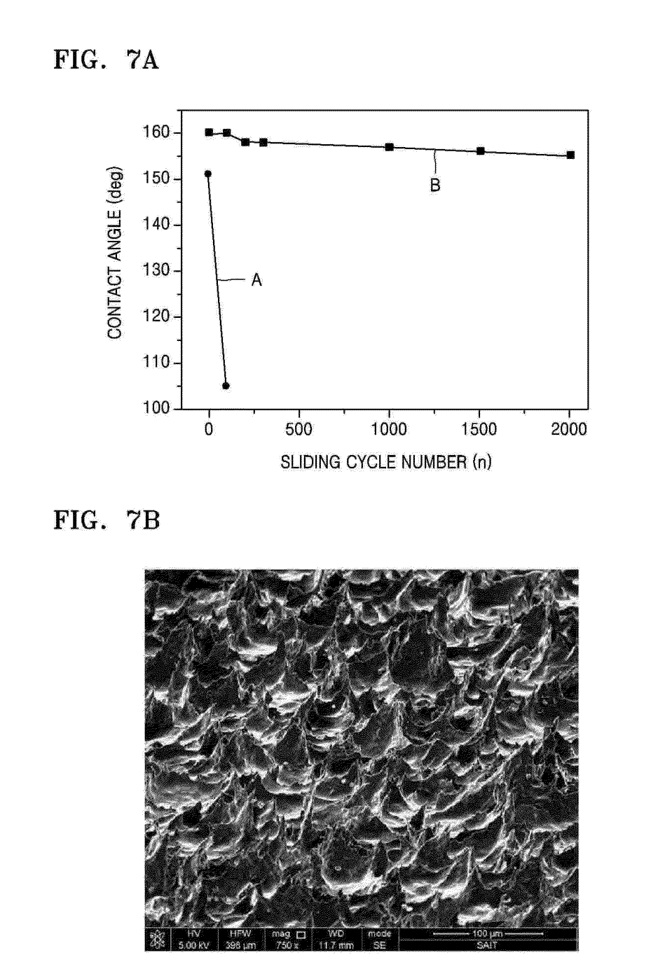

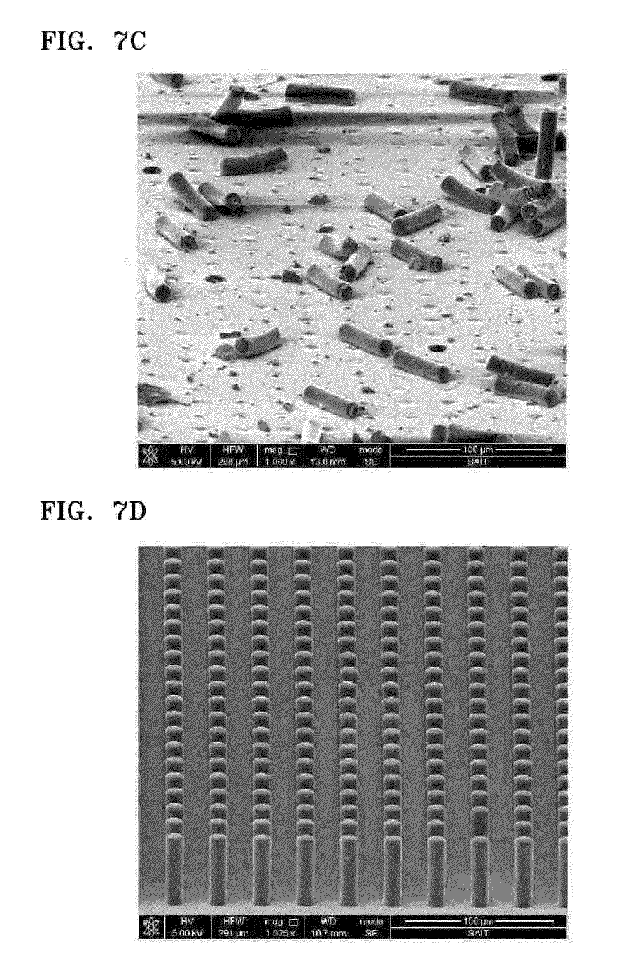

FIG. 7A is a graph illustrating the results of a durability test of the nano-composite layer, when a velocity of a first roll is 55 rpm and a contact angle is 161°, as shown in Table 1, and a general pillar-type nano-composite layer. In FIG. 7A, A refers to the general pillar-type nano-composite layer and B refers to the nano-composite layer, that is formed when a velocity of a first roll is 55 rpm and a contact angle is 161°. Also, FIGS. 7B and 7C respectively illustrate states of the nano-composite layer that is formed when the velocity of the first roll is 55 rpm and the contact angle is 161°, and the general pillar-type nano-composite layer, by using a scanning electron microscope (“SEM”). FIG. 7D is an SEM image showing the state of the general pillar-type structure prior to the durability test to compare the results to FIG. 7C.

The durability test was performed through an abrasion tester revolving 42 times per minute by a straight-line alternating motion of a rubber stick having a diameter of 5 mm. After a predetermined number of tests, a state of surfaces of the nano-composite layers was analyzed by using an SEM apparatus and a contact angle. In this regard, the general pillar-type structure is the nano-composite prepared according to the Example of Korean Patent Registration No. 10-0758699.

Referring to FIGS. 7A through 7D, the nano-composite layer when the velocity was 55 rpm and the contact angle was 161° showed higher durability compared to the general pillar-type nano-composite.

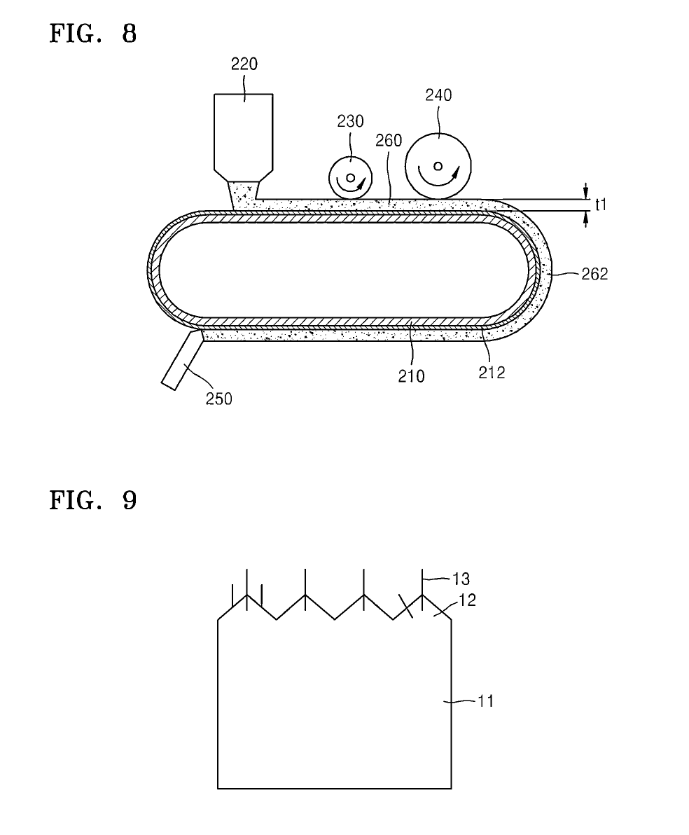

FIG. 8 schematically illustrates a cross-section of an apparatus used in a method of preparing the nano-composite layer with superhydrophobic surfaces.

Referring to FIG. 8, a dispenser 220 supplying a composition for the nano-composite layer, a flattening roll 230 that is a first apparatus for limiting a thickness of the composition for the nano-composite layer, and a first roll 240 rotating in a first direction are disposed on a continuously rotating conveyer belt 210 rotating in toward the flattening roll 230 and the first roll 240. Also, an apparatus for releasing the nano-composite layer may be attached to or operably associated with the conveyer belt 210. For example, a scraper (not shown in FIG. 8) may be further disposed on the conveyer belt 210.

The flattening roll 230 and the first roll 240 are each disposed on the conveyer belt 210 separated from each other by a predetermined distance. A thickness of the composition layer to be formed on the conveyor belt 210 may be determined by the vertical location of the flattening roll 230 with respect to the conveyer belt 210. A vertical distance between the first roll 240 and the conveyer belt 210 may be substantially equal to the vertical distance between the flattening roll 230 and the conveyer belt 210.

The first roll 240 may be made of stainless steel. Surfaces of the first roll 240 may be processed as rough surfaces. Alternatively, only some parts of the surfaces of the first roll 240 may be rough surfaces. Also, the surfaces of the first roll 240 may have regularly alternating rough surfaces and smooth surfaces as illustrated in FIG. 2B.

Hereinafter, a method of preparing the nano-composite layer with superhydrophobic surfaces according to another embodiment of the present inventive concept will be described with reference to FIG. 8.

First, a flattening roll 230 and a first roll 240 are disposed adjacent a conveyer belt 210 separated from each other, and each of the flattening roll 230 and the first roll 240 may be separated from a surface of the conveyor belt 210 by an equal first gap.

The first roll 240 and the conveyor belt 210 are rotated toward each other. The conveyer belt 210 is driven at a first velocity and the first roll 240 is rotated in the first direction at a linear velocity greater than or equal to the velocity of the conveyer belt 210. A velocity of the flattening roll 230 may be less than or equal to the velocity of the conveyer belt 210. Alternatively, the flattening roll 230 may be an idle roll which is rotated by the conveyer belt 210 with a layer disposed therebetween. Alternatively, a bar (not shown) may be disposed on the conveyer belt 210 in a width direction of the conveyer belt 210 instead of the flattening roll 230. The bar may be separated from the surface of the conveyer belt 210 by the first gap.

Thereafter, a composition for the nano-composite layer is dispensed from a dispenser 220. The composition for the nano-composite layer is a polymer impregnated with nano-fillers.

The composition for the nano-composite layer may be supplied to the conveyer belt 210 in a thickness greater than or equal to the first thickness t1.

A composition layer 260 having a thickness of t1 is formed on the conveyer belt 210 by the flattening roll 230.

A curable polymer or a thermoplastic polymer may be used as a polymer of the composition for the nano-composite layer with superhydrophobic surfaces.

Thereafter, when the composition layer 260 that passed through the flattening roll 230 contacts the first roll 240, the linear velocity of the first roll 240 is equal to or faster than the velocity of the conveyer belt 210, thereby applying shear stress on the composition layer 260. Accordingly, a portion of the surface of the composition layer 260 is detached from the composition layer 260. As a result, a superhydrophobic nano-pattern is formed on the surface of the composition layer 260. The resultant layer on the conveyer belt 210 is a nano-composite layer with superhydrophobic surfaces 262.

The shear stress is proportional to a shear rate. The shear rate is calculated by dividing a value obtained by subtracting the linear velocity of the conveyer belt 210 from the linear velocity of the first roll 240 by the first thickness t1, and is about 0 s⁻¹ to about −200 s⁻¹.

Thereafter, the nano-composite layer 262 passing through the first roll 240 is separated from the conveyer belt 210, for example when a scraper contacts the nano-composite layer 260. The scraper 250 may be disposed so as to contact the surface of the conveyer belt 210.

When the release layer 212 such as a polyimide layer is present on the conveyer belt 210 in advance, or when a conveyer belt 210 including a thermally resistant polymer is used, a process of releasing the nano-composite layer 260 from the conveyer belt 210 by using the scraper is facilitated.

The thermally resistant polymer may include, for example, polyimide.

When a polymer of the composition for the nano-composite layer is a thermoplastic polymer, a heat resistant belt and the like may be used as the conveyer belt 210, and a heat treatment (annealing) of the composition layer 260 at a temperature of about 100° C. to about 250° C. may be further performed before the composition layer 260 contacts the first roll 240. The heat resistant belt may be, for example, a polyimide belt.

According to the method of preparing described above, a superhydrophobic surface may be simply and easily formed on the nano-composite layer 262 in a large scale. Also, this method of preparing enables obtaining the nano-composite layers with superhydrophobic surfaces according to a large-scale preparing process while producing more uniform nano-composite layer and reducing loss of materials compared to when the nano-composite is formed according to a spray coating method. Also, the preparing method described above may be applied in various fields by providing numerous multi-functions by adding electrical or thermal characteristics according to a selection of materials for nano-fillers.

When the polymer of the composition for the nano-composites is a curable polymer, the nano-composite layer 262 is released from the conveyer belt 210, for example by using a scraper, and a curing of the nano-composite layer 262 by heating, for example at a temperature of about 100° C. to about 250° C. may be further performed. When the curable polymer is processed through the heat treatment, a curing reaction and/or a cross-link reaction of the curable polymers may occur.

The nano-composite layer according to an embodiment of the present inventive concept shows a high electrical conductivity of about 0.1 Siemens per meter (“S/m”) to about 500 S/m when a conductive filler is used. Also, the nano-composite layer has strong durability against external contacts and maintains superhydrophobicity under the load of for example, 1.5 Newton (“N”). In addition, the nano-composite layer according to an embodiment of the present inventive concept may show properties such as water resistance and antifouling. Accordingly, the nano-composite layer may reduce friction resistance and a drag of surfaces of materials, leading to fuel reduction effects of automobiles, ships, and aircrafts.

According to another aspect of the present inventive concept, there is provided a nano-composite including a bulk portion; a plurality of protrusions formed on the bulk body; a nano-filler exposed from surfaces of the plurality of protrusions, and the composition for the nano-composite layer described above or a cured product thereof.

FIG. 9 schematically illustrates a structure of the nano-composite layer.

Referring to FIG. 9, the nano-composite layer 10 includes a bulk body 11 and a plurality of protrusions 12 formed on the bulk body 11. Nano-fillers 13 are exposed on surfaces of the plurality of protrusions 12. A structure wherein the nano-fillers 13 are exposed may be confirmed through an SEM.

The nano-fillers 13 extend by protruding from the surfaces of the plurality of protrusions 12.

A length of the nano-fillers 13 extended from the surfaces of the plurality of protrusions 12 is for example, about 0.1 μm to about 5 μm on average.

The nano-composite layer has superhydrophobic surfaces wherein superhydrophobic surfaces are formed. The nano-composite layer having superhydrophobic surfaces has a contact angle of 140° or greater, for example, 150° or greater, and for example, in a range of about 150° to about 180°.

The superhydrophobic surfaces may have a pyramid form.

If the superhydrophobic surfaces are simply attached to a surface of a substrate formed of a general substrate material, e.g., silicon, glass, or a polymer, via a coating process, the nano-composite layer having superhydrophobic surfaces may be peeled off from the substrate, and durability may particularly be deteriorated when exposed to an outside environment. However, in a nano-composite according to an embodiment, the superhydrophobic surfaces are directly formed on a surface portion of a bulk body of the nano-composite layer, thus improving the resistance against wear-off or friction, and making the durability of the nano-composite layer excellent.

Hereinafter, a principle of forming the superhydrophobic surfaces in the nano-composites with superhydrophobic surfaces according to an embodiment of the present inventive concept will be described with reference to the attached drawings.

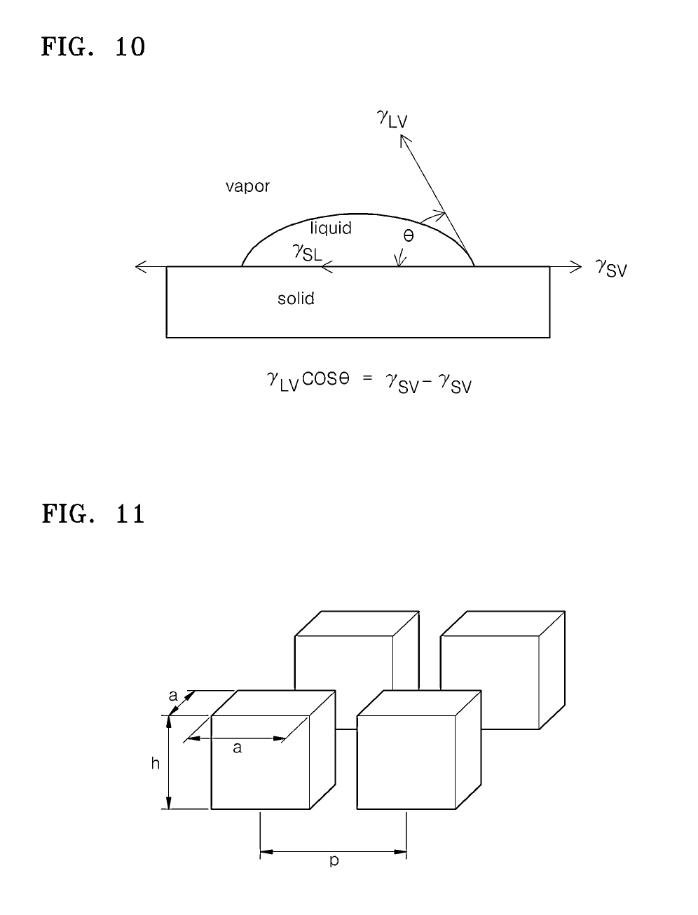

FIG. 10 illustrates a contact angle between vapor and a solid when a liquid drop is located on a surface of the solid. Here, solid surfaces are assumed to be flat without being separately processed.

A contact angle 8 between the liquid and the solid may be determined according to Young's Equation shown as Equation 1 below.

γ_{LV} cos θ=γ_{SV}−γ_{SL} Equation 1

Here, γ_{LV} denotes liquid-vapor interfacial tension or surface tension, γ_{SV} denotes solid-vapor interfacial tension, and γ_{SL} denotes solid-liquid interfacial tension. Here, if the surface of the solid is not flat and has irregularities thereon, the contact angle may be determined according to two models below instead of according to the Young's Equation.

The first model is a Wenzel model, which assumes that liquid drops completely wet the irregularities to the bottom thereof when the liquid drops are dropped on a surface of a solid where the irregularities are formed. The contact angle of the liquid drops on the surface of the solid where irregularities are formed is denoted by θ_{rw} and is represented by Equation 2 below.

cos θ_{rw}=r cos θ, r=A_{SL}/A_{F} Equation 2

Here, r denotes a ratio between an area A_{SL} at which the liquid drop actually contacts the surface of the solid and an area A_{F} projected from above and may be defined as a roughness factor. When it is assumed that a shape of the irregularities formed on the surface of the solid is a rectangular pillar as shown in FIG. 4B, the roughness factor r may be expressed as shown by Equation 3 below.

r=(4ah²+p²)/p² Equation 3

According to the first model, if the contact angle θ of the liquid drop on the flat surface of the solid is smaller than 90° (cos θ>0), the contact angle θ_{nw} of the liquid drop on the uneven surface of the solid is smaller than θ. On the contrary, if the contact angle θ of the liquid drop on the flat surface of the solid is greater than 90° (cos θ<0), the contact angle θ_{rw} of the liquid drop on the uneven surface of the solid is greater than θ.

The second model is a Classie's model in which it is assumed that, when a liquid drop is dropped an uneven surface of a solid, the liquid drop is located on the irregularities. Here, a contact angle θ_{rc} of the liquid drop on the uneven surface of the solid may be expressed as shown in Equation 4 below.

cos θ_{rc}=fₛ(1+cos θ)−1, fₛ=A_{SL}/A_{C} Equation 4

Here, fₛ (solid fraction) denotes a ratio between an area A_{SL} at which the liquid drop actually contacts the surface of the solid and an area A_{C} at which the liquid drop is projected onto the surface of the solid. If it is assumed that a shape of the irregularities formed on the surface of the solid has a rectangular pillar-like shape, fₛ may be expressed as shown in Equation 5 below.

fₛ=a²/p² Equation 5

When a liquid drop is dropped onto a surface of a solid, it may be determined which of the first and second models will be applied based on a tilting angle α of the irregularities formed on the surface of the solid and the contact angle θ. If a critical tilting angle is α₀ at which it is switched from the first model to the second model when a contact angle on a flat surface of a solid is θ, Equation 6 below is applied.

α0=180°−θ Equation 6

Referring to Equation 6, if a tilting angle of side surfaces of irregularities formed on a surface of a solid is smaller than the critical tilting angle (α<α₀), the first model may be applied. On the contrary, if a tilting angle of side surfaces of irregularities formed on a surface of a solid is greater than the critical tilting angle (α>α₀), the second model is applied.

For example, if a shape of irregularities formed on a surface of a solid has a rectangular pillar-like shape as shown in FIG. 4B, the dimension of a pattern, that is, a pattern lateral width a, a pattern pitch p, and a pattern height h are 6, 18, and 40, respectively. If a contact angle θ is 110°, a tilting angle of side surfaces is greater than the critical tilting angle (α>α₀), and thus the second model may be applied. Here, fₛ is 0.11, and θ_{rc} is 158°. When a superhydrophobic pattern having the same dimensions is actually formed by performing an imprinting process, a value similar to a theoretical contact angle of the second model, that is, 158°, may be obtained.

According to an aspect of the present inventive concept, a nano-composite with superhydrophobic surfaces having a uniform large-scale surface and durability by using viscosity and thixotropy of a composition for forming a nano-composite layer, may be easily obtained. The nano-composite with superhydrophobic surfaces may be easily and simply prepared in one step.

According to the principle described above, superhydrophobic surfaces may be formed so as to increase the contact angle and thus, a structure having capabilities such as self-cleaning, anti-water drop, and a low drag force may be achieved.

It should be understood that the exemplary embodiments described therein should be considered in a descriptive sense only. While the present inventive concept has been particularly shown and described with reference to exemplary embodiments thereof, it will be understood by those of ordinary skill in the art that various changes in form and details may be made therein without departing from the spirit and scope of the present inventive concept as defined by the following claims.

What is claimed is:

1. A method of preparing a nano-composite layer comprising superhydrophobic surfaces, the method comprising:
providing a first roll and a second roll with a predetermined gap therebetween;
rotating the first roll and the second roll in a direction towards each other, wherein a linear velocity of the first roll is greater than a linear velocity of the second roll;
supplying a composition for the nano-composite layer to the predetermined gap to form a composition layer having a first thickness on a circumference of the first roll;
adjusting the linear velocity of the first roll, the second roll, or both, such that the linear velocity of the second roll is greater than or equal to the linear velocity of the first roll to form the nano-composite layer; and
separating the nano-composite layer from the first roll,
wherein the composition for the nano-composite layer with superhydrophobic surfaces comprises a polymer and a nano-filler, and has a viscosity of about 10⁴ Pascals×second to about 10⁸ Pascals×second and a thixotropic index of 3 or greater.

2. The method of claim 1 wherein,
the polymer is a thermoplastic polymer, and
the forming of the composition layer further comprises heating the composition layer having the first thickness on a surface of the first roll.

3. The method of claim 1, wherein
the polymer is a curable polymer, and
the method further comprises curing the nano-composite layer separated from the first roll.

4. The method of claim 1, wherein the forming of the nano-composite layer comprises supplying a shear stress on a surface of the composition layer to detach a portion of the surface of the composition layer.

5. The method of claim 4, wherein a shear rate of the shear stress is about 0 seconds⁻¹ to about −200 seconds⁻¹.

6. The method of claim 1 further comprising
disposing a release layer on a surface of the first roll before the forming the nano-composite layer having the first thickness, and
wherein the separating of the nano-composite layer from the first roll comprises separating the nano-composite layer from the release layer.

7. The method of claim 1, wherein a content of the nano-filler in the composition for the nano-composite layer is about 5 weight % to about 20 weight %, and an aspect ratio of the nano-filler is about 5,000 to about 20,000.

8. A method of preparing a nano-composite layer with superhydrophobic surfaces, the method comprising:
providing a dispenser supplying a composition for the nano-composite layer with superhydrophobic surfaces, a first apparatus for adjusting a thickness of the composition, a first roll, and a conveyer belt at a predetermined distance from the first roll;
rotating the first roll and the conveyer belt in a direction towards each other;
dispensing the composition for the nano-composite layer from the dispenser onto the conveyer belt before contacting the first roll;
contacting the dispensed composition with the first apparatus to forma composition layer having a first thickness;
forming a nano-composite layer by contacting the composition layer with the first roll, wherein a linear velocity of the first roll is greater than or equal to a linear velocity of the conveyer belt; and
separating the nano-composite layer from the conveyer belt,
wherein the composition for the nano-composite layer with superhydrophobic surfaces comprises a polymer and a nano-filler, and has a viscosity of about 10⁴ Pascals×second to about 10⁸ Pascals×second and a thixotropic index of equal to or greater than 3.

9. The method of claim 8, wherein
the polymer is a thermoplastic polymer, and
the forming of the composition layer comprises heating the composition layer on the conveyer belt before contacting the first roll.

10. The method of claim 8, wherein
the rotating of the first roll comprises applying a shear stress on a surface of the composition layer to detach a portion of the surface of the composition layer.

11. The method of claim 10, wherein a shear rate of the shear stress is about 0 seconds⁻¹ to about −200 seconds⁻¹.

12. The method of claim 8, wherein
the first apparatus is a rotating roll or a bar spaced from the conveyer belt by a distance equal to the first thickness.

13. The method of claim 8, wherein
the polymer is a curable polymer, and
the method further comprises curing the nano-composite layer separated from the conveyer belt.

14. The method of claim 8, wherein a content of the nano-filler in the composition for the nano-composite layer is about 5 weight % to about 20 weight %, and an aspect ratio of the nano-filler is about 5,000 to about 20,000.

15. A composition for a nano-composite layer with superhydrophobic surfaces comprising a polymer and a nano-filler, wherein a viscosity of the composition is about 10⁴ Pascal×second to about 10⁸ Pascal×second and a thixotropic index is equal to or greater than 3.

16. The composition of claim 15, wherein a content of the nano-filler is about 5 weight % to about 20 weight %, and the nano-filler comprises carbon nano-tubes having an aspect ratio of about 5,000 to about 20,000.

17. The composition of claim 15, wherein the polymer is at least one curable polymer selected from polyorganosiloxane, polyurethane, unsaturated polyester, phenolics, epoxy resin, an alkyd molding compound, and an allyl resin, or at least one thermoplastic polymer selected from ethylene terpolymer, acrylonitrile butadiene-styrene copolymer, polymethyl methacrylate, methylpentene polymer, polyimide, polyvinylidene fluoride, polyvinylidene chloride, polycarbonate, polystyrene, polyamide, and polyester.

18. A nano-composite layer with superhydrophobic surfaces or a nano-composite layer with superhydrophobic surfaces comprising a cured product of the composition of claim 15 comprising:
a bulk body;
a plurality of protrusions formed on the bulk body; and
nano-fillers exposed on surfaces of the plurality of protrusions.

19. The nano-composite layer of claim 18, wherein the nano-fillers extend in one direction protruding from surfaces of the plurality of protrusions.

20. The nano-composite layer of claim 18, wherein the plurality of protrusions have a pyramid form.
